(19) United States
(12) Patent Application Publication
(10) Pub. No.: US 2026/0095854 A1
(43) Pub. Date: Apr. 2, 2026

(54) BASE STATION MANAGEMENT SYSTEM, BASE STATION MANAGEMENT METHOD AND RADIO NETWORK CONTROLLER

(71) Applicant: LITE-ON TECHNOLOGY CORPORATION, TAIPEI CITY (TW)

(72) Inventors: Pei-Hsuan LIN, Taipei City (TW); Wei-Chuang HUANG, Taipei City (TW)

(21) Appl. No.: 19/234,653

(22) Filed: Jun. 11, 2025

Related U.S. Application Data
(60) Provisional application No. 63/700,798, filed on Sep. 30, 2024.

(30) Foreign Application Priority Data
Mar. 5, 2025 (TW) 114108094

(51) Int. Cl. H04W 52/02

(52) U.S. Cl. CPC H04W 52/0206

(57) ABSTRACT

A base station management system is provided. The base station management system may include a plurality of base stations and a radio network controller (RNC). The RNC may be connected to the base stations. The RNC may periodically receive a report from each base station. According to the report from each base station, the RNC may determine whether to indicate one or more of the base stations to enter or leave a power-saving status. The report comprises user equipment (UE) information and throughput information.

### CROSS REFERENCE TO RELATED APPLICATIONS

This application claims the priority of U.S. Provisional Application No. 63/700,798 filed on Sep. 30, 2024, and TW patent application No. 114108094 filed on Mar. 5, 2025, the entirety of which is incorporated by reference herein.

### BACKGROUND OF THE INVENTION

### Field of the Invention

The invention generally relates to base station management technology, and more particularly, it relates to a base station management system in which a radio network controller is used to determine whether the base station needs to enter or leave power-saving status.

### Description of the Related Art

The Open Radio Access Network (O-RAN) structure of fifth generation (5G) communication is a new network structure established by global telecommunications providers. In the open standards, the 5G mobile network may be composed according to hardware and software from multiple vendors to achieve advantages of flexibility, openness, and low cost.

According to statistics provided by the O-RAN Alliance and the Mobile World Congress (MWC), the throughput of 5G small cells is growing. However, when many 5G small cells are deployed in an area (or space), the amount of power used by the base stations will increase significantly. Therefore, how to control the power consumption of base stations more efficiently is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to base station management with respect to the base station management system and the radio network controller (RNC). It is believed that the issue described above can be avoided or otherwise alleviated by implementing one or more of the proposed schemes described herein.

An embodiment of the invention provides a base station management system. The base station management system may comprise a plurality of base stations and a radio network controller (RNC). The RNC may be connected to the base stations. The RNC may periodically receive a report from each base station, and according to the report from each base station, determining whether to indicate one or more of the base stations to enter or leave a power-saving status. The report comprises user equipment (UE) information and throughput information.

In some embodiments, the UE information may comprise the number of UEs connected to each base station, and the throughput information comprises the uplink (UL) throughput and the downlink (DL) throughput of each base station.

In some embodiments, when the total number of UEs connected to the base stations is less than the first predetermined value, or when the total UL throughput of the base stations is less than a first threshold and the total DL throughput of all the base stations is less than a second threshold, the RNC may indicate the first number of base stations to enter the power-saving status.

In some embodiments, when the total number of UEs connected to the base stations is less than the second predetermined value, or when the total UL throughput of the base stations is less than a third threshold and the total DL throughput of the base stations is less than a fourth threshold, the RNC may indicate the second number of base stations to enter the power-saving status. The second predetermined value is less than the first predetermined value. The third threshold is less than the first threshold. The fourth threshold is less than the second threshold. The second number is greater than the first number.

In some embodiments, when the total number of UEs connected to the base stations is greater than a first predetermined value, or when the total UL throughput of the base stations is greater than a first threshold and the total DL throughput of the base stations is greater than a second threshold, the RNC may indicate one or more base stations in the power-saving status to leave the power-saving status.

In some embodiments, the power-saving status may comprise disconnecting the connection with a core network or entering a sleep mode.

In some embodiments, before the RNC indicates one of the base stations to enter the power-saving status, the RNC may determine whether a handover operation of a UE originally connected to the base station has been successful.

In some embodiments, if the handover operation of the UE originally connected to the base station has been successful, the RNC may indicate the base station to enter the power-saving status.

An embodiment of the invention provides a base station management method. The base station management method may be applied to a base station management system. The base station management method may comprise that the radio network controller (RNC) of the base station management system may periodically receive a report from each of a plurality of base stations of the base station management system. The base station management method may also comprise that according to the report from each base station, the RNC may determine whether to indicate one or more of the base stations to enter or leave a power-saving status, wherein the report comprises user equipment (UE) information and throughput information.

An embodiment of the invention provides a radio network controller (RNC). The RNC may comprise a communication device and a processor. The communication device may be connected to a plurality of base stations through a communication interface to periodically receive a report from each base station. According to the report from each base station, the processor may determine whether to indicate one or more of the base stations to enter or leave a power-saving status, wherein the report comprises user equipment (UE) information and throughput information.

Other aspects and features of the invention will become apparent to those with ordinary skill in the art upon review of the following descriptions of specific embodiments of the base station management method and system, and the RNC.

### BRIEF DESCRIPTION OF THE DRAWINGS

The invention will become more fully understood by referring to the following detailed description with reference to the accompanying drawings, wherein:

FIG. 1 is a block diagram of a base station management system 100 according to an embodiment of the application.

FIG. 2 is a schematic diagram illustrating a communication interface according to an embodiment of the invention.

FIG. 3 is a block diagram illustrating an RNC 300 according to an embodiment of the invention.

FIG. 4 is a block diagram illustrating a base station 400 according to an embodiment of the invention.

FIG. 5 is a flow chart 500 illustrating a base station management method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

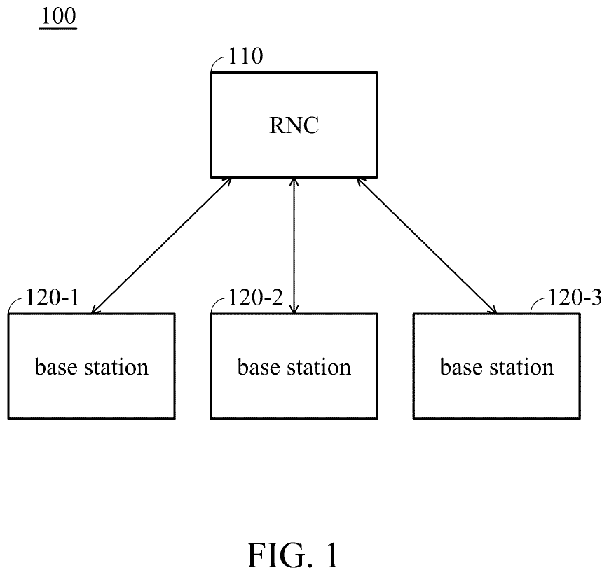

FIG. 1 is a block diagram of a base station management system 100 according to an embodiment of the application. As shown in FIG. 1, the base station management system 100 may comprise a radio network controller (RNC) 110, and a plurality of base stations 120-1, 120-2, and 120-3. It should be noted that, in order to clarify the concept of the invention,

FIG. 1 presents a simplified block diagram in which only the elements relevant to the invention are shown. However, the invention should not be limited to what is shown in FIG. 1. For example, the base station management system 100 may also comprise different numbers of base stations.

According to an embodiment of the invention, the RNC 110 may periodically obtain the report from each base station (e.g., base stations 120-1, 120-2 and 120-3) connected to (or linked with) the RNC 110, and according to all reports, indicate one or more of the base stations connected to the RNC 110 to enter or leave a power-saving status. According to an embodiment of the invention, the report of each base station may comprise the user equipment (UE) information and throughput information. The UE information may comprise the number of UEs connected to each base station (i.e., the number of UEs that the base station is serving), and the throughput information may comprise the uplink (UL) throughput and downlink (DL) throughput of each base station. According to an embodiment of the invention, the power-saving status may comprise that the connection between the base station and a core network is disconnected, or the base station enters a sleep mode (e.g., the radio unit (RU) of the base station is disabled).

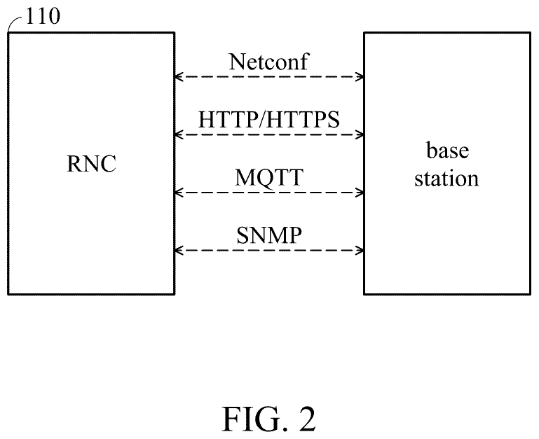

The RNC 110 may perform data transmission with the base station (e.g., base stations 120-1, 120-2 and 120-3) through a wire or wireless communication method. The RNC 110 may perform the data transmission with the base station according to one or more of the Hyper Text Transfer Protocol (HTTP) (or Hyper Text Transfer Protocol Secure (HTTPS)), Network Configuration Protocol (Netconf), Message Queuing Telemetry Transport (MQTT) protocol, and Simple Network Management Protocol (SNMP), but the invention should not be limited thereto. Taking FIG. 2 as an example, FIG. 2 is a schematic diagram illustrating a communication interface according to an embodiment of the invention. As shown in FIG. 2, the RNC 110 may perform data transmission with the base station through the communication interface based on HTTP (or HTTPS), Netconf, MQTT, or SNMP.

According to an embodiment of the invention, the base stations 120-1, 120-2 and 120-3 may comprise a small base station, small cell, evolved Node B (eNB), next generation Node B (gNB) or transmission reception point (TRP), but the invention should not be limited thereto. In addition, according to an embodiment of the invention, the type of the base stations 120-1, 120-2, and 120-3 may be all-in-one base station, but the invention should not be limited thereto. That is, each of the base stations 120-1, 120-2, and 120-3 may comprise a radio unit (RU), a distributed unit (DU), and a central unit (CU). In the embodiments of the invention, each base station 120-1, 120-2, and 120-3 may establish the connection with the same or different number of UEs to provide network service to the UE (or UEs) connected with it.

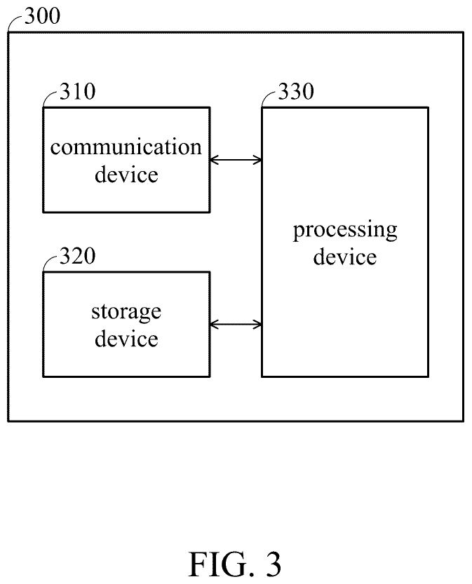

FIG. 3 is a block diagram illustrating an RNC 300 according to an embodiment of the invention. The RNC 300 may be the RNC 110. As shown in FIG. 3, the RNC 300 may comprise a communication device 310, a storage device 320, and a processing device 330. It should be noted that, in order to clarify the concept of the invention, FIG. 3 presents a simplified block diagram in which only the elements relevant to the invention are shown. However, the invention should not be limited to what is shown in FIG. 3.

The communication device 310 may transmit data or information to the base station or receive data or information from the base station through a communication interface. According to an embodiment of the invention, the communication interface may be the communication interface based on HTTP (or HTTPS), Netconf, MQTT, or SNMP (e.g., the communication interfaces shown in FIG. 2).

The storage device 320 may store the software and firmware program codes, system data, user data, etc. of the RNC 300. The storage device 320 may be a volatile memory such as a Random Access Memory (RAM); a non-volatile memory such as a flash memory or Read-Only Memory (ROM); a hard disk; or any combination thereof.

The processing device 330 may control the operations of the communication device 310 and the storage device 320. According to an embodiment of the invention, the processing device 330 may also be arranged to execute the program codes stored in the storage device 320. The program codes, accompanied by specific data in a data structure, may also be referred to as a processor logic unit or a stack instance when being executed. Therefore, the processing device 330 may be regarded as being comprised of a plurality of processor logic units, each processor logic unit executing one or more specific functions or tasks of corresponding software modules.

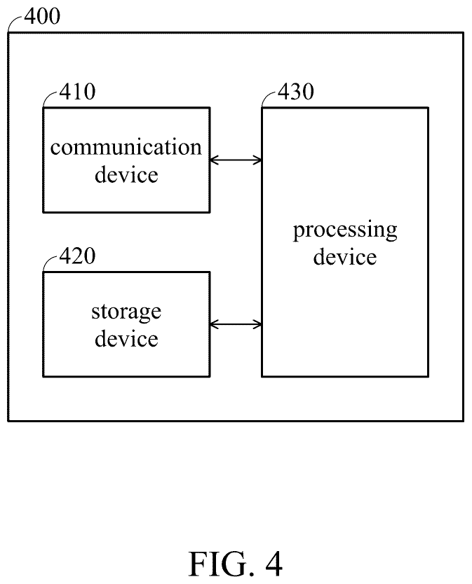

FIG. 4 is a block diagram illustrating a base station 400 according to an embodiment of the invention. The base station 400 may be any of the base stations 120-1, 120-2, and 120-3. As shown in FIG. 4, the base station 400 may comprise a communication device 410, a storage device 420, and a processing device 430. It should be noted that, in order to clarify the concept of the invention, FIG. 4 presents a simplified block diagram in which only the elements relevant to the invention are shown. However, the invention should not be limited to what is shown in FIG. 4.

The communication device 410 may transmit data or information to the RNC or receive data or information from the RNC through a communication interface. According to an embodiment of the invention, the communication interface may be the communication interface based on HTTP (or HTTPS), Netconf, MQTT, or SNMP (e.g., the communication interfaces shown in FIG. 2).

The storage device 420 may store the software and firmware program codes, system data, user data, etc. of the base station 400. The storage device 420 may be a volatile memory such as a Random Access Memory (RAM); a non-volatile memory such as a flash memory or Read-Only Memory (ROM); a hard disk; or any combination thereof.

The processing device 430 may control the operations of the communication device 410 and the storage device 420. According to an embodiment of the invention, the processing device 430 may also be arranged to execute the program codes stored in the storage device 420. The program codes, accompanied by specific data in a data structure, may also be referred to as a processor logic unit or a stack instance when being executed. Therefore, the processing device 430 may be regarded as being comprised of a plurality of processor logic units, each processor logic unit executing one or more specific functions or tasks of corresponding software modules.

According to an embodiment of the invention, the RNC 110 may periodically obtain the report from each base station (e.g., base stations 120-1, 120-2, and 120-3) connected to the RNC 110. The RNC 110 may determine the current loading status of each base station according to all obtained reports, and according to the current loading status of each base station, the RNC 110 may dynamically adjust one or more of the base stations connected to the RNC 110 to enter or leave a power-saving status.

In an embodiment, when the RNC 110 determines that the loading status of the base stations is changed from a high loading status to a medium loading status (e.g., the total number of UEs connected with the base stations is less than the first predetermined value, and/or the total UL throughput of the base stations is less than a first threshold and the total DL throughput of the base stations is less than a second threshold) according to the reports of the base stations, the RNC 110 may indicate (or adjust) the first number of the base stations to enter the power-saving status. Furthermore, when the RNC 110 determines that the loading status of the base stations is changed from a medium loading status to a low loading status (e.g., the total number of UEs connected with the base stations is less than the second predetermined value, and/or the total UL throughput of the base stations is less than a third threshold and the total DL throughput of the base stations is less than a fourth threshold) according to the reports of the base stations, the RNC 110 may indicate (or adjust) the second number of the base stations to enter the power-saving status. The second predetermined value may be less than the first predetermined value, the third threshold may be less than the first threshold, the fourth threshold may be less than the second threshold, and the second number may be greater than the first number. In the other words, when the loading status of the base stations is changed from the high loading status to the medium loading status, since the second number is greater than the first number (i.e., the number of UEs connected to the base station when the second number of the base stations enter the power-saving status is fewer than the number of UEs connected to the base station when the first number of the base stations enter the power-saving status), the RNC 110 may determine to indicate (or adjust) the first number of the base stations to enter the power-saving status first.

Conversely, when the RNC 110 determines that the loading status of the base stations is changed from the low loading status to the medium loading status (e.g., the total number of UEs connected with the base stations is greater than (or equal to) the second predetermined value, and/or the total UL throughput of the base stations is greater than (or equal to) the third threshold and the total DL throughput of the base stations is greater than (or equal to) the fourth threshold) according to the reports of the base stations, the RNC 110 may indicate (or adjust) the second number of the base stations to leave the power-saving status. In addition, when the RNC 110 determines that the loading status of the base stations is changed from the medium loading status to the high loading status (e.g., the total number of UEs connected with the base stations is greater than (or equal to) the first predetermined value, and/or the total UL throughput of the base stations is greater than (or equal to) the first threshold and the total DL throughput of the base stations is greater than (or equal to) the second threshold) according to the reports of the base stations, the RNC 110 may indicate (or adjust) the first number of the base stations to leave the power-saving status.

For example, in a space (e.g., an office), an RNC 110 and three base stations are configured, and the three base stations can serve 30 UEs. When the RNC 110 determines that the number of UEs connected with the base stations is less than 2/3 total service volume (i.e., (2/3)*30=20 UEs), and/or the total UL throughput of the base stations is less than 300 million bits per second (300 Mbps) and the total DL throughput of the base stations is less than 1800 Mbps according to the reports of the base stations (i.e., the loading status of the base stations is changed from the high loading status to the medium status), the RNC 110 may indicate (or adjust) one of the three base stations to enter the power-saving status (e.g., the connection between the base station and the core network is disconnected), the remaining two base stations still maintain the service status (i.e., the connections between the base stations and the core network are maintained to provide service to the UEs). In addition, when the RNC 110 determines that the number of UEs connected with the base stations is less than 1/3 total service volume (i.e., (1/3)*30=10 UEs), and/or the total UL throughput of the base stations is less than 150 Mbps and the total DL throughput of the base stations is less than 900 Mbps according to the reports of the base stations (i.e., the loading status of the base stations is changed from the medium loading status to the low status), the RNC 110 may indicate (or adjust) two of the three base stations to enter the power-saving status (e.g., the connection between one base station and the core network may be disconnected, and the other base station may enter a sleep mode, but the invention should not be limited thereto), only one base station still maintains the service status.

Conversely, when the RNC 110 determines that the number of UEs connected with the base stations is changed to be greater than (or equal to) 1/3 total service volume (i.e., (1/3)*30=10 UEs), and/or the total UL throughput of the base stations is changed to be greater than (or equal to) 150 Mbps and the total DL throughput of the base stations changed to be greater than (or equal to) 900 Mbps according to the reports of the base stations (i.e., the loading status of the base stations is changed from the low loading status to the medium status), the RNC 110 may indicate (or adjust) one base station which is in the power-saving status to leave the power-saving status (e.g., the connection between the base station and the core network may be restored, but the invention should not be limited thereto), i.e., two base stations will be in the service status. In addition, when the when the RNC 110 determines that the number of UEs connected with the base stations is changed to be greater than (or equal to) 2/3 total service volume (i.e., (2/3)*30=20 UEs), and/or the total UL throughput of the base stations is changed to be greater than (or equal to) 300 million bits per second (300 Mbps) and the total DL throughput of the base stations is changed to be greater than (or equal to) 1800 Mbps according to the reports of the base stations (i.e., the loading status of the base stations is changed from the medium loading status to the high status), the RNC 110 may indicate (or adjust) all three base stations to leave power-saving status (e.g., the connection between the base station in the sleep mode and the core network will be restored, but the invention should not be limited thereto), i.e., all three base stations will be in the service status.

It should be noted that the above examples are only used to illustrate the embodiments of the invention, but the invention should not be limited thereto. The base or conditions for the determination of the RNC 110 can be appropriately modified and adjusted according to different environments and deployments of apparatus.

According to an embodiment of the invention, the RNC 110 may hourly determine whether the loading status of the base stations is changed from the high loading status to the medium status, or whether the loading status of the base stations is changed from the medium loading status to the low loading status.

According to an embodiment of the invention, the RNC 110 may determine every minute whether the loading status of the base stations is changed from the medium loading status to the high status, or whether the loading status of the base stations is changed from the low loading status to the medium loading status.

According to an embodiment of the invention, before the RNC 110 indicates one base station to enter the power-saving status, the RNC 110 may indicate the UE (or UEs) connected with the base station to perform the handover operation through the base station first. The RNC 110 may determine whether the handover operation of the UE (or UEs) originally connected with the base station has been successful to determine whether to indicate the base station to enter the power-saving status. If the handover operation of the UE (or UEs) originally connected with the base station has been successful, the RNC 110 may indicate the base station to enter the power-saving status. If the handover operation of the UE (or UEs) originally connected with the base station fails, the RNC 110 may not indicate the base station to enter the power-saving status to avoid service interruption. For example, referring to FIG. 1, before the RNC 110 indicates the base station 120-1 to enter the power-saving status, the RNC 110 may indicate the UEs connected with the base station 120-1 to perform the handover operation through the base station 120-1 first. If the handover operation of the UEs originally connected with the base station 120-1 has been successful (e.g., handover from the base station 120-1 to the base station 120-2), the RNC 110 may indicate the base station 120-1 to enter the power-saving status. If the handover operation of the UEs originally connected with the base station 120-1 fails, the RNC 110 may not indicate the base station 120-1 to enter the power-saving status.

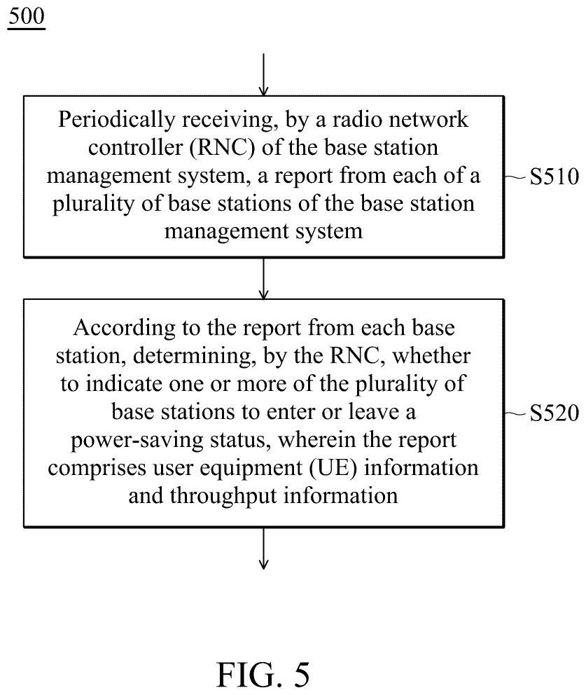

FIG. 5 is a flow chart 500 illustrating a base station management method according to an embodiment of the invention. The base station management method can be applied to the base station management system 100. As shown in FIG. 5, in step S510, the RNC 110 of the base station management system 100 may periodically receive a report from each base station of the base station management system 100.

In step S520, according to the report from each base station, the RNC 110 may determine whether to indicate one or more of the base stations of the base station management system 100 to enter or leave a power-saving status, wherein the report may comprise the UE information and the throughput information.

According to an embodiment of the invention, in the base station management method, the UE information may comprise the number of UEs connected to each base station of the base station management system 100, and the throughput information may comprise the UL throughput and DL throughput of each base station of the base station management system 100.

According to an embodiment of the invention, in the base station management method, when the total number of UEs connected to the base stations of the base station management system 100 is less than a first predetermined value, or when the total UL throughput of the base stations of the base station management system 100 is less than a first threshold and the total DL throughput of the base stations of the base station management system 100 is less than a second threshold, the RNC 110 of the base station management system 100 may indicate the first number of the base stations of the base station management system 100 to enter the power-saving status.

According to an embodiment of the invention, in the base station management method, when the total number of UEs connected to the base stations of the base station management system 100 is less than a second predetermined value, or when the total UL throughput of the base stations of the base station management system 100 is less than a third threshold and the total DL throughput of the base stations of the base station management system 100 is less than a fourth threshold, the RNC 110 of the base station management system 100 may indicate the second number of the base stations of the base station management system 100 to enter the power-saving status. The second predetermined value may be less than the first predetermined value, the third threshold may be less than the first threshold, the fourth threshold may be less than the second threshold, and the second number may be greater than the first number.

According to an embodiment of the invention, in the base station management method, when the total number of the UEs connected to the base stations of the base station management system 100 is greater than a first predetermined value, or when the total UL throughput of the base stations of the base station management system 100 is greater than a first threshold and the total DL throughput of the base stations of the base station management system 100 is greater than a second threshold, the RNC 110 of the base station management system 100 may indicate one or more base stations which are in the power-saving status to leave the power-saving status.

According to an embodiment of the invention, in the base station management method, the power-saving status may comprise disconnecting a connection with a core network or entering a sleep mode.

According to an embodiment of the invention, in the base station management method, before the RNC 110 of the base station management system 100 indicates one of the base stations to enter the power-saving status, the RNC 110 of the base station management system 100 may determine whether a handover operation of a UE originally connected to the base station has been successful. If the handover operation of the UE originally connected to the base station has been successful, the RNC 110 of the base station management system 100 may indicate the base station to enter the power-saving status.

According to the base station management method provided in the embodiments of the invention, the RNC of the base station manage system can dynamically and immediately determine whether to indicate one or more base stations of the base station management system to enter or leave the power-saving status. Therefore, according to the base station management method provided in the invention, the power consumption of the base stations can be reduced.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A base station management system, comprising:
a plurality of base stations; and
a radio network controller (RNC), connected to the plurality of base stations, periodically receiving a report from each base station, and according to the report from each base station, determining whether to indicate one or more of the plurality of base stations to enter or leave a power-saving status,
wherein the report comprises user equipment (UE) information and throughput information.

2. The base station management system of claim 1, wherein the UE information comprises a number of UEs connected to each base station, and the throughput information comprises an uplink (UL) throughput and a downlink (DL) throughput of each base station.

3. The base station management system of claim 2, wherein when a total number of UEs connected to the plurality of base stations is less than a first predetermined value, or when a total UL throughput of the plurality of base stations is less than a first threshold and a total DL throughput of the plurality of base stations is less than a second threshold, the RNC indicates a first number of the plurality of base stations to enter the power-saving status.

4. The base station management system of claim 3, wherein when the total number of UEs connected to the plurality of base stations is less than a second predetermined value, or when the total UL throughput of the plurality of base stations is less than a third threshold and the total DL throughput of the plurality of base stations is less than a fourth threshold, the RNC indicates a second number of the plurality of base stations to enter the power-saving status, wherein the second predetermined value is less than the first predetermined value, the third threshold is less than the first threshold, the fourth threshold is less than the second threshold, and the second number is greater than the first number.

5. The base station management system of claim 2, wherein when a total number of UEs connected to the plurality of base stations is greater than a first predetermined value, or when a total UL throughput of the plurality of base stations is greater than a first threshold and a total DL throughput of the plurality of base stations is greater than a second threshold, the RNC indicates one or more of the plurality of base stations which are in the power-saving status to leave the power-saving status.

6. The base station management system of claim 1, wherein the power-saving status comprises disconnecting a connection with a core network or entering a sleep mode.

7. The base station management system of claim 1, wherein before the RNC indicates one of the plurality of base stations to enter the power-saving status, the RNC determines whether a handover operation of a UE originally connected to the base station has been successful.

8. The base station management system of claim 7, wherein if the handover operation of the UE originally connected to the base station has been successful, the RNC indicates the base station to enter the power-saving status.

9. A base station management method, applied to a base station management system, comprising:
periodically receiving, by a radio network controller (RNC) of the base station management system, a report from each of a plurality of base stations of the base station management system; and
according to the report from each base station, determining, by the RNC, whether to indicate one or more of the plurality of base stations to enter or leave a power-saving status,
wherein the report comprises user equipment (UE) information and throughput information.

10. The base station management method of claim 9, wherein the UE information comprises a number of UEs connected to each base station, and the throughput information comprises an uplink (UL) throughput and a downlink (DL) throughput of each base station.

11. The base station management method of claim 10, further comprising:
when a total number of UEs connected to the plurality of base stations is less than a first predetermined value, or when a total UL throughput of the plurality of base stations is less than a first threshold and a total DL throughput of the plurality of base stations is less than a second threshold, indicating, by the RNC, a first number of the plurality of base stations to enter the power saving status.

12. The base station management method of claim 11, further comprising:
when the total number of UEs connected to the plurality of base stations is less than a second predetermined value, or when the total UL throughput of the plurality of base stations is less than a third threshold and the total DL throughput of the plurality of base stations is less than a fourth threshold, indicating, by the RNC, a second number of the plurality of base stations to enter the power-saving status,
wherein the second predetermined value is less than the first predetermined value, the third threshold is less than the first threshold, the fourth threshold is less than the second threshold, and the second number is greater than the first number.

13. The base station management method of claim 10, further comprising:
when a total number of UEs connected to the plurality of base stations is greater than a first predetermined value, or when a total UL throughput of the plurality of base stations is greater than a first threshold and a total DL throughput of the plurality of base stations is greater than a second threshold, indicating, by the RNC, one or more of the plurality of base stations which are in the power-saving status to leave the power-saving status.

14. The base station management method of claim 9, wherein the power-saving status comprises disconnecting a connection with a core network or entering a sleep mode.

15. The base station management method of claim 9, further comprising:
before the RNC indicates one of the plurality of base stations to enter the power-saving status, determining, by the RNC, whether a handover operation of a UE originally connected to the base station has been successful.

16. The base station management method of claim 15, further comprising:
if the handover operation of the UE originally connected to the base station has been successful, indicating, by the RNC, the base station to enter the power-saving status.

17. A radio network controller (RNC), comprising:
a communication device, connected to a plurality of base stations through a communication interface to periodically receive a report from each base station; and
a processor, according to the report from each base station, determining whether to indicate one or more of the plurality of base stations to enter or leave a power-saving status,
wherein the report comprises user equipment (UE) information and throughput information.

18. The RNC of claim 17, wherein the UE information comprises a number of UEs connected to each base station, and the throughput information comprises an uplink (UL) throughput and a downlink (DL) throughput of each base station.

19. The RNC of claim 17, wherein the power-saving status comprises disconnecting a connection with a core network or entering a sleep mode.

20. The RNC of claim 17, wherein before the RNC indicates one of the plurality of base stations to enter the power-saving status, the processor determines whether a handover operation of a UE originally connected to the base station has been successful, and wherein if the handover operation of the UE originally connected to the base station has been successful, the processor indicates the base station to enter the power-saving status.
